(19) United States
(12) Patent Application Publication
(10) Pub. No.: US 2009/0231419 A1
(43) Pub. Date: Sep. 17, 2009

(54) Endoscope Assembly and Method of Performing a Medical Procedure

(75) Inventor: Lex Bayer, Palo Alto, CA (US)

Correspondence Address: SQUIRE, SANDERS & DEMPSEY L.L.P., 1 MARITIME PLAZA, SUITE 300, SAN FRANCISCO, CA, 94111, US

(73) Assignee: Avantis Medical Systems, Inc., Sunnyvale, CA (US)

(21) Appl. No.: 12/251,383

(22) Filed: Oct. 14, 2008

Related U.S. Application Data
(63) Continuation-in-part of application No. 11/672,020, filed on Feb. 6, 2007.
(60) Provisional application No. 60/979,367, filed on Oct. 11, 2007.

(51) Int. Cl. H04N 7/18

(52) U.S. Cl. 348/76; 348/E07.085

(57) ABSTRACT

An endoscope assembly includes (1) an endoscope that includes a tubular body, a retrograde-viewing imaging device disposed at a distal end region of the tubular body, and a channel extending through the tubular body; and (2) an instrument extending through the channel of the endoscope and exits from a distal opening of the channel.

This application claims the benefit of U.S. Provisional Patent Application No. 60/979,367, filed Oct. 11, 2007, the entire disclosure of which is incorporated herein by reference.

This application is a continuation-in-part application of U.S. patent application Ser. No. 11/672,020, filed Feb. 6, 2007, the entire disclosure of which is incorporated herein by reference.

### TECHNICAL FIELD OF THE INVENTION

The present invention relates to an endoscope assembly and a method of performing a medical procedure.

### BACKGROUND OF THE INVENTION

An endoscope is a medical device comprising a flexible tube and a camera mounted on the distal end of the tube. The endoscope is insertable into an internal body cavity through a body orifice or a surgical incision to examine the body cavity and tissues for diagnosis. The tube of the endoscope has one or more longitudinal channels, through which an instrument can reach the body cavity to take samples of suspicious tissues or to perform other surgical procedures such as polypectomy.

There are many types of endoscopes, and they are named in relation to the organs or areas with which they are used. For example, gastroscopes are used for examination and treatment of the esophagus, stomach and duodenum; colonoscopes for the colon; bronchoscopes for the bronchi; laparoscopes for the peritoneal cavity; sigmoidoscopes for the rectum and the sigmoid colon; arthroscopes for joints; cystoscopes for the urinary bladder; and angioscopes for the examination of blood vessels.

Many conventional endoscopes are characterized by a single forward viewing camera mounted at the distal end of the endoscope to transmit an image to an eyepiece or video display at the proximal end. The camera is used to assist a medical professional in advancing the endoscope into a body cavity and looking for abnormalities. The camera provides the medical professional with a two-dimensional view from the distal end of the endoscope. To capture an image from a different angle or in a different portion, the endoscope must be repositioned or moved back and forth. Repositioning and movement of the endoscope prolongs the procedure and causes added discomfort, complications, and risks to the patient. Additionally, in an environment such as the lower gastro-intestinal tract, flexures, tissue folds and unusual geometries of the organ may prevent the endoscope's camera from viewing the “hidden” areas of the organ and prevent the instrument from reaching the “hidden” areas (or at least make it difficult for the instrument to reach these same areas). The inability to view the “hidden” areas may cause a potentially malignant polyp to be missed, and the inability (or difficulty) to reach the “hidden” areas may require an expensive and intrusive procedure to remove the polyp (or at least prolong the procedure to use the endoscope to remove the polyp). Furthermore, it is difficult to optimally remove a potentially malignant polyp using a conventional endoscope. The difficulty to see and reach a polyp often results in only partial removal of the polyp or removal of normal tissues in addition to the polyp, which increases the risk of the procedure to the patient. For example, to remove only the polyp without normal tissues requires a proper placement of a snare around the polyp. With a conventional endoscope, this is difficult to accomplish if the polyp is in a “hidden” area, because the inability or difficulty to see how the snare is placed round the polyp.

### SUMMARY OF THE INVENTION

This problem associated with prior art endoscopes is overcome by the present invention. In one preferred embodiment, the present invention provides (1) an instrument that can reach areas that are difficult or impossible to reach with an instrument extending through a channel in the main endoscope and (2) possibly a second, auxiliary camera that presents an image from a different point-of-view and enables viewing of areas not viewable by the endoscope's main camera. This arrangement of cameras may provide different views of an area, and this arrangement of instruments may allow the instruments to reach an area from different angles. In another preferred embodiment, the second camera and instrument may be integrated to allow, for example, easy handling and cooperation between the second camera and the instrument.

According to one aspect of the invention, an endoscope assembly includes an endoscope that includes a tubular body, a retrograde-viewing imaging device disposed at a distal end region of the tubular body, and a channel extending through the tubular body; and an instrument extending through the channel of the endoscope and exits from a distal opening of the channel.

According to one embodiment of the invention, the instrument includes a cable and a head disposed at a distal end of the cable.

According to another embodiment of the invention, the head includes one of a snare, an electrocautery or a biopsy forceps.

According to still another embodiment of the invention, the cable includes an electrical wire for providing electric power to the head.

According to yet another embodiment of the invention, a portion of the instrument that extends outside of the distal opening of the channel of the endoscope includes a bend.

According to still yet another embodiment of the invention, the instrument bends at an angle between 30°to 150°.

According to a further embodiment of the invention, the instrument bends at an angle between 45° to 135°.

According to a still further embodiment of the invention, the instrument bends at an angle between 45° to 90°.

According to a yet further embodiment of the invention, at least the portion of the instrument forming the bend is made from a flexible shape memory material.

According to a still yet further embodiment of the invention, at least a distal portion of the instrument is steerable.

According to another further embodiment of the invention, the instrument is moveable along the channel of the endoscope and rotatable relative to the channel of the endoscope.

According to still another further embodiment of the invention, the distal opening of the channel is on a side surface of the distal end region of the tubular body.

According to yet another further embodiment of the invention, the distal opening of the channel is on a distal end of the tubular body.

According to still yet another further embodiment of the invention, the channel of the tubular body and the instrument are integrated so that the instrument cannot be removed from the channel, but the instrument has limited movement in or out of the channel.

According to another embodiment of the invention, the opening of the channel is on a distal end region of the endoscope, and the instrument projects forwards beyond the endoscope.

According to still another embodiment of the invention, the endoscope is a minor endoscope. The endoscope assembly further includes a main endoscope that includes an insertion tube, a forward-viewing imaging device disposed at a distal end region of the insertion tube, and a channel extending through the insertion tube. The minor endoscope extends through the channel of the insertion tube and exits from a distal opening of the channel of the insertion tube.

According to yet another embodiment of the invention, the minor endoscope is moveable along the channel of the insertion tube and rotatable relative to the channel of the insertion tube.

According to still yet another further embodiment of the invention, the endoscope assembly further includes a control box connected to the instruments to provide a monopolar current to the instruments.

According to another aspect of the invention, an endoscope assembly includes an endoscope that includes a tubular body and a retrograde-viewing imaging device disposed at a distal end region of the tubular body; and an instrument fixed to the distal end region of the tubular body.

According to one embodiment of the invention, the instrument includes a cable and a head disposed at a distal end of the cable.

According to another embodiment of the invention, the head includes one of a snare, an electrocautery or a biopsy forceps.

According to still another embodiment of the invention, the cable includes an electrical wire for providing electric power to the head.

According to yet another embodiment of the invention, the instrument is perpendicular to the distal end region of the tubular body.

According to still yet another embodiment of the invention, at least the portion of the instrument is made from a flexible shape memory material.

According to a further embodiment of the invention, the endoscope is a minor endoscope. The endoscope assembly further includes a main endoscope that includes an insertion tube, a forward-viewing imaging device disposed at a distal end region of the insertion tube, and a channel extending through the insertion tube. The minor endoscope extends through the channel of the insertion tube and exits from a distal opening of the channel of the insertion tube.

According to a still further embodiment of the invention, the minor endoscope is moveable along the channel of the insertion tube and rotatable relative to the channel of the insertion tube.

According to a yet further embodiment of the invention, the endoscope assembly further includes a control box connected to the instruments to provide a monopolar current to the instruments.

### BRIEF DESCRIPTION OF THE DRAWINGS

FIG. 1 shows a perspective view of an endoscope system with a major endoscope and a minor endoscope according to one embodiment of the present invention.

FIG. 2 shows a perspective view of the minor endoscope shown in FIG. 1.

FIG. 3 shows a perspective view of the distal end of the endoscope system of FIG. 1.

FIG. 4 shows a perspective view of the endoscope system of FIG. 1 with an instrument.

FIG. 5 shows a perspective view of the endoscope system of FIG. 1 with another instrument.

FIG. 6 shows a perspective view of the endoscope system of FIG. 1 with still another instrument.

FIG. 7 shows a perspective view of the endoscope system of FIG. 1 with a further instrument.

FIG. 8 shows a perspective view of the endoscope system of FIG. 1 with a still further instrument.

FIG. 9 shows a perspective view of a portion of a link belonging to the minor endoscope shown in FIG. 2.

FIG. 10 shows an exploded perspective view of the link belonging to the minor endoscope of FIG. 2.

FIG. 11 shows a perspective view of an endoscope system with a major endoscope and a minor endoscope according to another embodiment of the present invention.

FIG. 12 shows a perspective view of the endoscope system of FIG. 11 with an instrument extending from an opening on a side of the minor endoscope.

FIG. 13 shows a perspective view of the endoscope system of FIG. 11 with an instrument extending from an opening on an end of the minor endoscope.

### DETAILED DESCRIPTION OF EMBODIMENTS OF THE INVENTION

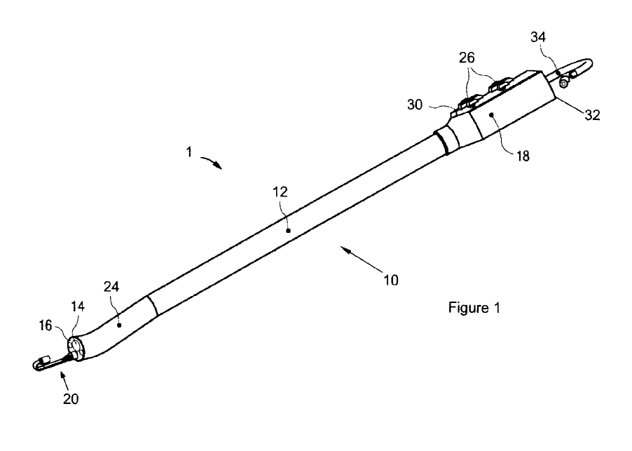

FIG. 1 illustrates a first exemplary endoscope system 1 of the present invention. This endoscope system 1 can be used in a variety of medical procedures in which imaging of a body tissue, organ, cavity or lumen is required. The types of procedures include, for example, anoscopy, arthroscopy, bronchoscopy, colonoscopy, cystoscopy, EGD, laparoscopy, and sigmoidoscopy.

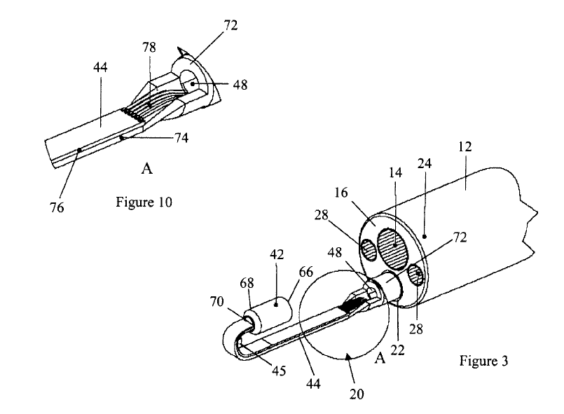

The endoscope system 1 of FIG. 1 includes a main endoscope 10 and a minor endoscope 20. The main endoscope 10 includes an insertion tube 12, a main imaging device 14 disposed at the distal end 16 of the insertion tube 12 (FIG. 3), and a control handle 18 connected to the proximal end of the insertion tube 12. The minor endoscope 20 is disposed at the distal and proximal ends of the insertion tube 12 and inside the insertion tube 12.

In the main endoscope 10, the insertion tube 12 may be detachable from the control handle 18 or may be integrally formed with the control handle 18. The diameter, length and flexibility of the insertion tube 12 depend on the procedure for which the endoscope system 1 is used.

In the illustrated embodiment, as shown in FIG. 3, the main endoscope's insertion tube 12 has one longitudinal channel 22 for accommodating the minor endoscope 20. In general, however, the insertion tube 12 may have one or more additional longitudinal channels through which an instrument, in addition to the minor endoscope 20, can reach the body cavity to perform any desired procedures, such as to take samples of suspicious tissues or to perform other surgical procedures such as polypectomy. The instruments may be, for example, a retractable needle for drug injection, hydraulically actuated scissors, clamps, grasping tools, electrocoagulation systems, ultrasound transducers, electrical sensors, heating elements, laser mechanisms and other ablation means. In some embodiments, one of the channels can be used to supply a washing liquid such as water for washing. A cap (not shown) may be included at the opening of the washing channel to divert the washing liquid onto a lens of the main imaging device 14 for cleaning. Another or the same channel may be used to supply a gas, such as CO₂ or air, into the organ. The channels may also be used to extract fluids or inject fluids, such as a drug in a liquid carrier, into the body. Various biopsy, drug delivery, and other diagnostic and therapeutic devices may also be inserted via the channels to perform specific functions.

The insertion tube 12 preferably is steerable or has a steerable distal end region 24 as shown in FIG. 1. The length of the distal end region 24 may be any suitable fraction of the length of the insertion tube 12, such as one half, one third, one fourth, one sixth, one tenth, or one twentieth. The insertion tube 12 may have control cables (not shown) for the manipulation of the insertion tube 12. Preferably, the control cables are symmetrically positioned within the insertion tube 12 and extend along the length of the insertion tube 12. The control cables may be anchored at or near the distal end 16 of the insertion tube 12. Each of the control cables may be a Bowden cable, which includes a wire contained in a flexible overlying hollow tube. The wires of the Bowden cables are attached to controls 26 in the handle 18. Using the controls, the wires can be pulled to bend the distal end region 24 of the insertion tube 12 in a given direction. The Bowden cables can be used to articulate the distal end region 24 of the insertion tube 12 in different directions.

The main imaging device 14 at the distal end 16 of the insertion tube 12 may include, for example, a lens, single chip sensor, multiple chip sensor or fiber optic implemented devices. The main imaging device 14, in electrical communication with a processor and/or monitor, may provide still images or recorded or live video images. In addition to the main imaging device 14, the distal end 16 of the insertion tube 12 may include one or more light sources 28 (FIG. 3), such as light emitting diodes (LEDs) or fiber optical delivery of light from an external light source. The light sources 28 preferably are equidistant from the main imaging device 14 to provide even illumination. The intensity of each light source 28 can be adjusted to achieve optimum imaging. The circuits for the main imaging device 14 and light sources 28 may be incorporated into a printed circuit board (PCB).

The insertion tube 12 may include a flexible ribbon coil (not shown) and a flexible sheath (not shown) that is used to protect the internal components of the insertion tube 12, such as the channels, wires and cables, from the environment of the body.

Preferably, the control handle 18 has one or more ports and/or valves (not shown) for controlling access to the channels of the insertion tube 12. The ports and/or valves can be air or water valves, suction valves, instrumentation ports, and suction/instrumentation ports. As shown in FIG. 1, the control handle 18 may additionally include a buttons 30 for taking pictures with the main imaging device 14, the minor endoscope 20, or both.

The proximal end 32 of the control handle 18 may include an accessory outlet 34 (FIG. 1) that provides fluid communication between the air, water and suction channels and the pumps and related accessories. The same outlet or a different outlet can be used for electrical lines to light and imaging components at the distal end of the endoscope system 1.

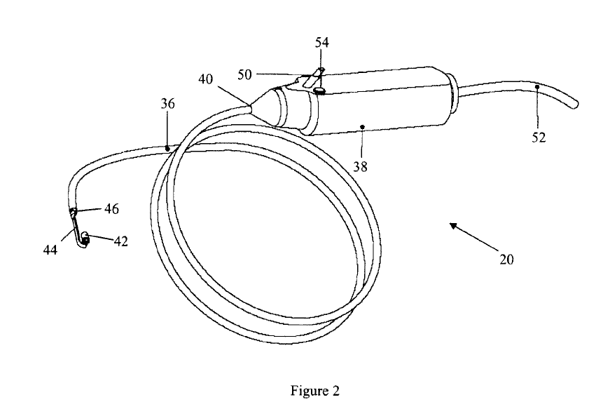

As shown in FIG. 2, the minor endoscope 20 may include a tubular body 36, a handle 38 connected to the proximal end 40 of the tubular body 36, an auxiliary imaging device 42, a link 44 that provides physical and/or electrical connection between the auxiliary imaging device 42 to the distal end 46 of the tubular body 36, and a light source 45 (illustrated in FIG. 3).

The minor endoscope 20 is used to provide an auxiliary imaging device at the distal end of the endoscope system 1. To this end, the minor endoscope 20 is placed inside the channel 22 of the main endoscope's insertion tube 12 with its auxiliary imaging device 42 disposed beyond the distal end 16 of the main endoscope 10. This can be accomplished by first inserting the distal end of the minor endoscope 20 into the main endoscope's channel 22 from the main endoscope's handle 18 and then pushing the minor endoscope 20 further into the channel 22 until the auxiliary imaging device 42 and link 44 of the minor endoscope 20 are positioned outside the distal end 16 of the main endoscope 10 as shown in FIG. 3.

The tubular body 36 of the minor endoscope 20 may have any suitable configuration. In terms of its length, the tubular body 36 preferably is sufficiently long such that the auxiliary imaging device 42 and link 44 can extend beyond the distal end 16 of the main endoscope 10. The preferred cross-section of the illustrated tubular body 36 is circular, although the cross-section may have any other suitable configuration, such as an elliptical or polygonal configuration.

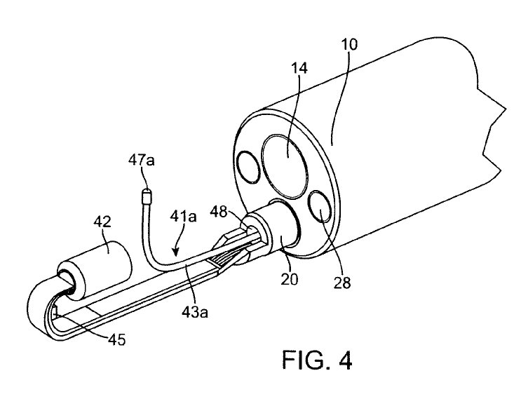

In the illustrated embodiment, as shown in FIG. 3, the tubular body 36 of the minor endoscope 20 has a channel 48 expanding the entire length of the tubular body 36. This channel 48 may be used to accommodate an instrument 41, such as snares, electrocautery or biopsy forceps. The instrument 41 extends from the proximal end of the minor endoscope 20 to the distal end and exits at the distal end of the channel 48. FIGS. 4-7 illustrate four examples 41a, 41b, 41c, 41d of such an instrument 41.

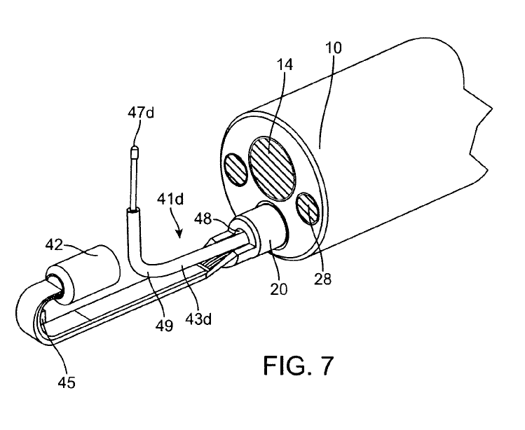

The instrument 41 can be used to reach areas that are difficult or impossible to reach with an instrument extending through a channel in the main endoscope 10. The two instruments can reach an area from different angles. As shown in FIGS. 4-7, the instrument 41 may include a cable 43 (43a, 43b, 43c, 43d) and a head 47 (47a, 47b, 47c, 47d) attached to the distal end of the cable 43. The instrument 41 may include also a handle (not shown). In some embodiments, the cable 43 may be a wire or a plurality of wires that are braided together. The cable 43 or a portion thereof may be made from a conducting metal such as steel or copper and may be used to conduct electricity to the head 47 of the instrument 41 to burn polyps. A sheath 49 can be included which wraps around the cable 43d as shown in FIG. 7 to protect the electrical wires running through the cable 43d.

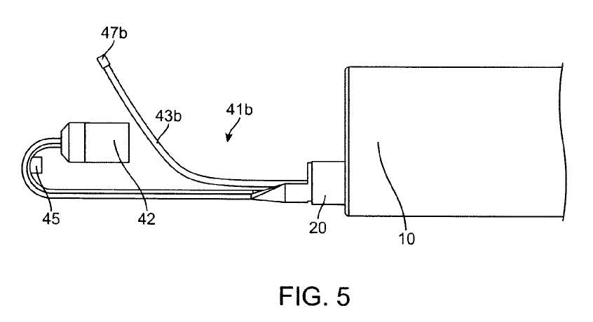

In some preferred embodiments, the distal portion of the cable 43 may be pre-shaped to a number of forms as shown in FIGS. 4, 5, 6 and 7. For example, the cables 43a, 43c, 43d shown in FIGS. 4, 6 and 7 bend at a 90° angle. In FIG. 5, the cable 43b bends at about a 130° angle. In general, the cable 43 may bend at any angle such as 15°, 30°, 45°, 60°, 75°, 105°, 120°, 135°, 150°, 165°, or 180°, or any angle within the range between any two of these angle values. As used herein, the “angle” means that the angle between the two portions of the cable that form the bend. For example, the cable 43b in FIG. 5 bends at about a 130° angle, not at about a 50° angle. In some embodiments, the cable 43 may be made at least partially made from a flexible shape memory material that tends to return substantially to its original shape after deformation. Such a cable 43 may be straightened to allow the distal end of the instrument 41 to be inserted into the proximal end of the minor endoscope's channel 48 and then pushed towards the distal end of the minor endoscope 20. When the distal end of the instrument 41 is pushed sufficiently out of the distal end of the minor endoscope's channel 48, the distal end of the instrument 41 resumes its natural bent configuration as shown in FIG. 4, 5, 6, or 7.

Alternatively, the instrument 41 or its distal end may be steerable. The instrument 41 may have control cables (not shown) for the manipulation of the instrument 41. Preferably, the control cables are symmetrically positioned within the instrument 41 and extend along the length of the instrument 41. The control cables may be anchored at or near the distal end of the instrument 41. Each of the control cables may be a Bowden cable, which includes a wire contained in a flexible overlying hollow tube. The wires of the Bowden cables are attached to controls on the handle of the instrument 41. Using the controls, an operator can pull the wires to bend the instrument 41 in a given direction.

The instrument 41 is free to move in the minor endoscope's channel 48, and this movement can be effected by pulling, pushing or rotating the handle of the instrument 41. This allows the instrument 41 to be independently manipulated with respect to the minor endoscope 20. The minor endoscope's channel 48 may be coated with a protective coating such as Teflon to avoid damages to the instrument 41. Furthermore, the minor endoscope's channel 48 may be reinforced with a lubricious liner such as PTFE or polyimide tubing to provide a lubricious surface to facilitate the movement of the instrument 41. This channel 48 may also be used to control the flow of air into the body cavity (suction or insufflation) as well as to pass fluids such as water into the body cavity.

In order to create a sufficient space for the channel 48, the electrical wires running through the wall can be coiled along the length of the instrument 41. Instead of following a path that is parallel to the length of the instrument 41, the electric wires can spiral around the channel in the wall of the instrument 41, allowing more electric wires to be included in the wall of the instrument 41.

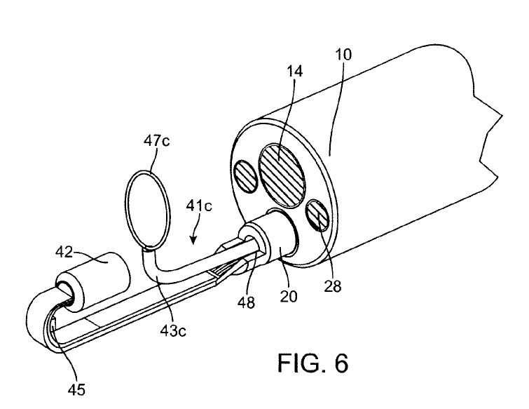

The head 47 of the instrument 41 may be of any one of various devices. For example, the head 47a, 47b, 47d can be a probe such as an electrocautery. The head 47c can also be shaped like a snare to facilitate the grasping of peduncled lesions or polyps as shown in FIG. 6. The cable 43c of the instrument 41c may be hollow, allowing the snare 47c to extend therethrough. An operator may tighten the snare 41 c by pulling it from the proximal end of the instrument 41c. The head 41 may further be biopsy forceps. The head 41 may also include a connector (not shown) to mate with a separate electrocautery generator.

The maneuvering of the head 47 to reach the desired location can be accomplished by manipulating the instrument 41 relative to the minor endoscope 20 and/or by manipulating the minor endoscope 20 relative to the main endoscope 10.

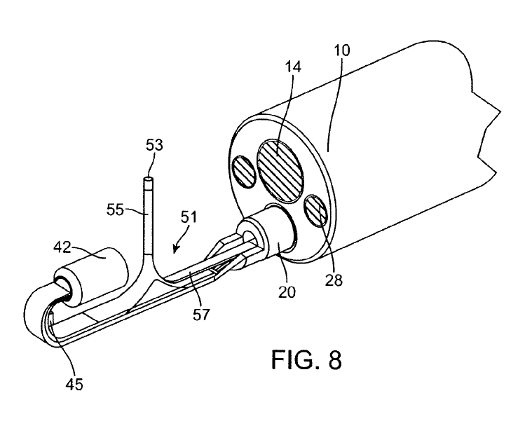

As shown in FIG. 8, an instrument 51 may also be fixed to the minor endoscope 20 rather than being separate from the minor endoscope 20, as shown in FIG. 4-7. In the embodiment shown in FIG. 8, the instrument 51 includes a head 53 and a short cable 55 connecting the head 53 to the link 44 of the minor endoscope 20, although the head 53 can be connected to any part of the minor endoscope 20. The head 53 may be the same or similar to any of the heads 47a, 47b, 47c, 47d shown in FIG. 4-7. The head 53 shown in FIG. 8 may be brought into contact with a desired area by manipulating the minor endoscope 20 relative to the main endoscope 10. This creates a system without multiple components that have to be controlled. The fixed instrument 51 can be pre-shaped with the aid of a shape-memory material such as nitinol. This allows the instrument 51 to be flattened when the minor endoscope 20 slides through the channel 22 of the main endoscope 10. In addition, a bridge 57 may be provided to connect the tubular body 36 of the minor endoscope 20 to the instrument 51 in order to conduct electricity to the instrument 51.

The handle 38 of the minor endoscope 20 may control various functions of the minor endoscope 20. For example, the handle 38 may serve as a convenient way to deploy and/or rotate the minor endoscope 20 inside the channel 22 of the main endoscope 10. The handle 38 may also provide an access port 50 for the channel 48 of the tubular body 36. The handle 38 may additionally provide a connector 52, to which electrical conductors from the auxiliary imaging device 42 and other components of the minor endoscope 20 are connected. The connector 52 can be used to connect the auxiliary imaging device 42 and other components to a device outside of the minor endoscope 20, such as a control box. The handle 38 may further provide a switch 54 that is used to operate the auxiliary imaging device 42 to capture still images.

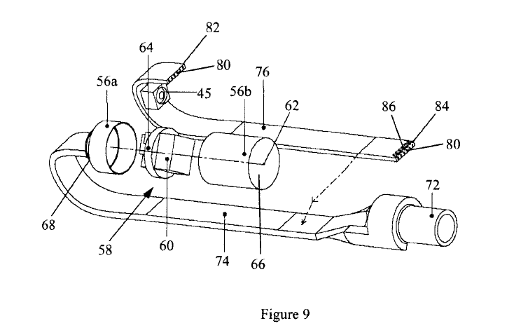

As shown in FIG. 9, the auxiliary imaging device 42 may include a housing 56a, 56b and an imaging unit 58 disposed in the housing 56a, 56b. In this embodiment, the housing 56a, 56b has a generally cylindrical configuration, but in general the housing may have any suitable configuration such as a spherical or cubic configuration. The housing 56a, 56b includes two parts 56a, 56b that are sealingly joined to form the housing 56a, 56b. The housing 56a, 56b may be made from any suitable material such as stainless steel or a plastic material.

As shown in FIG. 9, the imaging unit 58 may include a lens 62, an imaging sensor 60, and a printed circuit board (PCB) 64 containing electrical components of the imaging unit 58. The lens 62 is installed in an aperture on a first end 66 of the housing 56a, 56b, and may include a plurality of optical elements in a holder or barrel which focuses the incoming light from the surroundings onto a photosensitive area of the image sensor 60.

The imaging sensor 60 may be an electronic device which converts light incident on photosensitive semiconductor elements into electrical signals. The imaging sensor 60 may detect either color or black-and-white images. The signals from the imaging sensor 60 can be digitized and used to reproduce an image that is incident on the imaging sensor 60. Two commonly used types of image sensors are Charge Coupled Devices (CCD) such as a VCC-5774 produced by Sanyo of Osaka, Japan and Complementary Metal Oxide Semiconductor (CMOS) camera chips such as an OVT 6910 produced by OmniVision of Sunnyvale, Calif.

Alternatively, the imaging unit 58 may include a coherent fiber optic bundle and a lens for channeling light into the coherent fiber optic bundle, which then delivers the light from the distal end of the minor endoscope 20 to an imaging sensor located at the proximal end of, or external to, the imaging catheter.

On its second end 68, the housing 56a, 56b of the auxiliary imaging device 42 may include an opening 70 (FIG. 3) for a flexible PCB 76 (FIG. 9) to pass through for connection with the imaging unit 58. The flexible PCB 76 electrically connects the imaging unit 58 to the electrical conductors 78 (FIG. 10) which extend through tubular body 36.

When the minor endoscope 20 is properly installed in the insertion tube 12, the auxiliary imaging device 42 of the minor endoscope 20 preferably faces backwards towards the main imaging device 14 as illustrated in FIG. 3. The auxiliary imaging device 42 may be oriented so that the auxiliary imaging device 42 and the main imaging device 14 have adjacent or overlapping viewing areas. Alternatively, the auxiliary imaging device 42 may be oriented so that the auxiliary imaging device 42 and the main imaging device 14 simultaneously provide different views of the same area. Preferably, the auxiliary imaging device 42 provides a retrograde view of the area, while the main imaging device 14 provides a front view of the area.

As shown in FIGS. 2 and 3, the link 44 connects the auxiliary imaging device 42 to the distal end 46 of the tubular body 36. Preferably, the link 44 is a flexible link that is at least partially made from a flexible shape memory material that tends to return substantially to its original shape after deformation. Shape memory materials are well known and include shape memory alloys and shape memory polymers. A suitable flexible shape memory material is a shape memory alloy such as nitinol. The flexible link 44 is straightened to allow the distal end of the minor endoscope 20 to be inserted into the proximal end of channel 22 of the insertion tube 12 and then pushed towards the distal end 16 of the insertion tube 12. When the flexible link 44 is straightened inside the channel 22 of the insertion tube 12, the first end 66 of the auxiliary imaging device 42 faces away from the tubular body 36, a direction parallel to the main imaging device 14, while the second end 68 of the auxiliary imaging device 42 faces back towards the tubular body 36 and handle 38. When the auxiliary imaging device 42 and flexible link 44 are pushed sufficiently out of the distal end 16 of the insertion tube 12, the flexible link 44 resumes its natural bent configuration as shown in FIG. 3. The natural configuration of the flexible link 44 is the configuration of the flexible link 44 when the flexible link 44 is not subject to any force or stress. When the flexible link 44 resumes its natural bent configuration, the first end 66 of the auxiliary imaging device 42 faces substantially back towards the tubular body 36 (FIG. 2) and back towards the distal end 16 of the insertion tube 12 (FIG. 3) while the second end 68 of the auxiliary imaging device 42 faces away from the tubular body 36 (FIG. 2) and away from the distal end 16 of the insertion tube 12 (FIG. 3).

The flexible link may have any suitable configuration that allows it to be straightened under force and to return to its natural bent configuration when the force is removed. For example, the flexible link may have a U-shaped, S-shaped, right angle, or ramp configuration. In the illustrated embodiment, the flexible link 44 has a U-shaped natural configuration with two end segments that are substantially parallel to each other. Preferably, the distance between the end segments is equal to or less than a diameter of the insertion tube. One of the end segments is connected to the auxiliary imaging device 42 and other end segment is connected to the tubular body 36. Although the end segment connected to the tubular body 36 is much longer in the illustrated embodiment, the end segment connected to the auxiliary imaging device 42 may be longer in other embodiments. The flexible link 44 may have a generally elongated flat configuration with a hollow tubular end 72 for connection to the tubular body 36. As shown in FIG. 9, the hollow tubular end 72 of the flexible link 44 may be attached to the distal end 46 of the tubular body 36 by concentrically mating with the channel 48 of the tubular body 36. The attachment may be accomplished by any suitable means including adhesive bonding, welding or soldering. At the other end, the flexible link 44 may be joined to the auxiliary imaging device 42 by any suitable means such as adhesive bonding, welding or soldering.

In the illustrated embodiment, as shown in FIGS. 9 and 10, the flexible link 44 may include a flexible shape memory element 74 and a flexible PCB 76 that electrically connects the auxiliary imaging device 42 to the electrical conductors 78 in the tubular body 36. The flexible shape memory element 74 preferably performs the shape memory function of the flexible link 44, and the flexible PCB 76 is attached to the flexible shape memory element 74 so that its shape changes with the shape of the flexible shape memory element 74. Alternatively, the flexible PCB 76 and flexible shape memory element 74 may be merely placed next to one another but not attached. Even when the flexible PCB 76 and flexible shape memory element 74 are not attached to each other, they will still undergo substantially the same shape changes as long as they are appropriately configured (such as if their lengths are similar). In the illustrated embodiment, the flexible shape memory element 74 and flexible PCB 76 have a similar configuration and are stacked in the thickness direction of the flexible PCB 76 to form a layered structure. In general, however, they may have different configurations and may be arranged relative to each other in any other suitable manner.

As shown in FIG. 9, the flexible PCB 76 includes electrical conductors 80 that connect the auxiliary imaging device 42 to the electrical conductors 78 in the tubular body 36. At one end 82 of the flexible PCB 76, the electrical conductors 80 of the flexible PCB 76 are connected to the auxiliary imaging device 42. At the other end 84 of the flexible PCB 76, the electrical conductors 80 of the flexible PCB 76 are connected to the electrical conductors 78 in the tubular body 36. This end 84 of the flexible PCB 76 may have pads 86 for the connection between the electrical conductors 78 and electrical conductors 80.

In the illustrated embodiment, the light source 45 (as well as other components) of the minor endoscope 20 is placed on the flexible link 44, in particular on the curved concave portion of the flexible link 44, although the light source 45 may be placed at any other suitable position, such as on the rear facing end of the auxiliary imaging device 42.

The flexible link may be encapsulated or shrouded by flexible tubing, heat-shrinkable tubing, urethanes, rubber or silicon so as to allow smooth profile transition from the tubular body to the imaging device. This encapsulation may be translucent to allow light from the light source to project through the encapsulation, or the encapsulation may include a window section around each light source.

Since the main imaging device 14 and its light source 28 face the auxiliary imaging device 42 and its light source 45, the light sources 28, 45 of the imaging devices 14, 42 may interfere with the opposing imaging device 42, 14. That is, light source 28 may shine directly into auxiliary imaging device 42 and light source 45 may shine directly into main imaging device 14, degrading both images. To reduce the interference, polarizer filters may be used with the imaging devices 14, 42 and light sources 28, 45. Specifically, the main imaging device 14 and/or its light source 28 may be covered by a first set of polarizer filters of a given orientation. And the auxiliary imaging device 42 and/or its light source 45 may be covered by a second set of polarizer filters orientated at 90° relative to the first set of polarizer filters. The use of polarizer filters to reduce light interference is well known and will not be described in further detail.

As an alternative to polarizer filters, the imaging devices 14, 42 and their light sources 28, 45 may be turned on and off alternately to reduce or prevent light interference. In other words, when the main imaging device 14 and its light sources 28 are turned on, the auxiliary imaging device 42 and its light source 45 are turned off. And when the main imaging device 14 and its light sources 28 are turned off, the auxiliary imaging device 42 and its light source 45 are turned on. Preferably, the imaging devices 14, 42 and their light sources 28, 45 are turned on and off at a sufficiently high frequency that eyes do not sense that the light sources are being turned on and off.

The auxiliary imaging device 42 and its light source 45 are connected to a control box (not shown) via electrical conductors that extend from the imaging device 42 and light source 45; through the flexible PCB 76, tubular body 36, and handle 38; to the control box. The electrical conductors may carry power and control commands to the auxiliary imaging device 42 and its light source 45 and image signals from the auxiliary imaging device 42 to the control box. In the illustrated embodiment, the electrical conductors 78 in the tubular body 36 may be embedded in the wall of the tubular body 36, or simply in the tubular body if the tubular body does not have a channel, during the fabrication process or disposed in the channel 48 of the tubular body 36. The embedding of the electrical conductors in the tubular body 36 may be done by a braiding or coiling process to achieve the desired stiffness of the tubular body 36. A short length of the embedded electrical conductors may be exposed at either end of the tubular body 36 to allow connections to be made. The connections may then be sealed by means of, for example, heat-shrinking tubing, a sheath or an adhesive.

The control box includes at least an image and signal processing device and a housing in which the image and signal processing device is disposed, although the control box can be configured in any suitable manner. The housing may include a control panel and connectors.

The control panel includes buttons and knobs for controlling the functionalities of the control box.

The image and signal processing device may include one or more integrated circuits and memory devices along with associated discrete components. The device allows image signals from the imaging devices 14, 42 to be processed for the enhancement of image quality, extraction of still images from the image signals, and conversion of video format for compatibility with the display device.

The control box preferably processes the video image signal from the auxiliary imaging device 42 and transmits it to a display device such as a television or a monitor such as a liquid crystal display monitor. Still images can be captured from the video image signal using the switch 54 on the handle 38 of the minor endoscope 20. The video image or still image may be displayed on the display device. The display device may also include textual data that are used to display information such as patient information, reference numbers, date, and/or time.

The image signal from the main imaging device 14 may also be processed by the control box in the same way that the image signal from the auxiliary imaging device 42 is processed. The images from the main and auxiliary imaging devices 14, 42 may be displayed on two separate monitors or on the same monitor with a split screen.

The control box may further be used to adjust the parameters of the imaging devices 14, 42 and their light sources 28, 45, such as brightness, exposure time and mode settings. The adjustment can be done by writing digital commands to specific registers controlling the parameters. The registers can be addressed by their unique addresses, and digital commands can be read from and written to the registers to change the various parameters. The control box can change the register values by transmitting data commands to the registers.

The control box may additionally be used as an interface to the patient records database. A large number of medical facilities now make use of electronic medical records. During the procedure relevant video and image data may need to be recorded in the patient electronic medical records (EMR) file. The signal processing circuit can convert image and video data to a format suitable for filing in the patient EMR file such as images in .jpeg, tif, or .bmp format among others. The processed signal can be transmitted to the medical professional's computer or the medical facilities server via a cable or dedicated wireless link. A switch on the control panel can be used to enable this transmission. Alternatively the data can be stored with a unique identification for the patient in electronic memory provided in the control box itself. The signal processing circuit can be utilized to convert the video and image data to be compatible with the electronic medical records system used by the medical professional. The processing may include compression of the data. A cable or a wireless link may be used to transmit the data to a computer.

The instruments 41, 51 shown in FIGS. 4-8 may be directly attached to the control box, which may include electronic circuits to administer a monopolar current to the instruments 41, 51. In such an embodiment, the control box preferably includes a connector for the instruments 41, 51 to transmit the monopolar current to the instruments 41, 51. In addition, the control box may include connections to a return electrode, which includes a pad that is attached to the patient. The control box in this embodiment may also include a knob which allows the operator to vary the wattage provided by the monopolar current. In a further embodiment, the control box may send a bipolar current through the instruments 41, 51, and a separate return electrode would not be needed. The return electrode may be integrated into the heads of the instruments 41, 51.

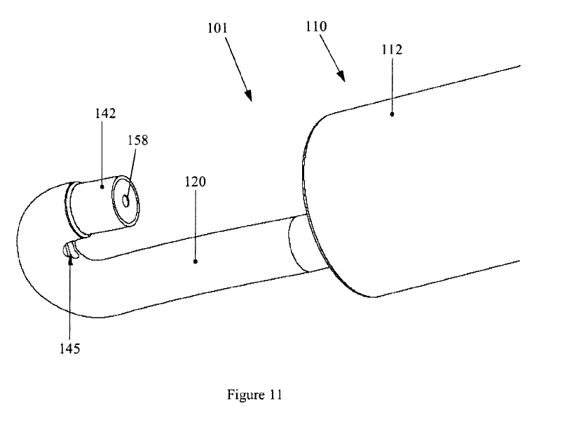

FIG. 11 illustrates a further embodiment of the present invention. In this embodiment, an endoscope system 101 includes a main endoscope 110 having an insertion tube 112, and an minor endoscope 120 positioned at the distal end of and inside the main endoscope 110. The minor endoscope 120 includes an auxiliary imaging device 142 disposed at the distal end of the minor endoscope 120. The auxiliary imaging device 142 includes an imaging unit 158 and a light source 145. When the minor endoscope 120 is properly installed in the main endoscope 110, the auxiliary imaging device 142 of the minor endoscope 20 preferably faces backwards towards the main imaging device (not shown). The auxiliary imaging device 142 may be oriented so that the auxiliary imaging device 142 and the main imaging device have adjacent or overlapping viewing areas. Alternatively, the auxiliary imaging device 142 may be oriented so that the auxiliary imaging device 142 and the main imaging device simultaneously provide different views of the same area. Preferably, the auxiliary imaging device 142 provides a retrograde view of the area, while the main imaging device provides a front view of the area. However, the auxiliary imaging device 142 could be oriented in other directions to provide other views, including views that are substantially parallel to the axis of the main imaging device.

The distal end region of the minor endoscope 120 preferably is made by shape setting of the minor endoscope 120 itself. This process is widely used and understood in the art and involves a process combination of heat and fixturing to create the pre-shaped distal end. The pre-shaped distal end may be supported by a piece of a shape memory material such as nitinol set in a similar shape. In general, this endoscope system 101 may be similar to the endoscope system 1 shown in FIGS. 1-10, except the distal end portion of the minor endoscope 120.

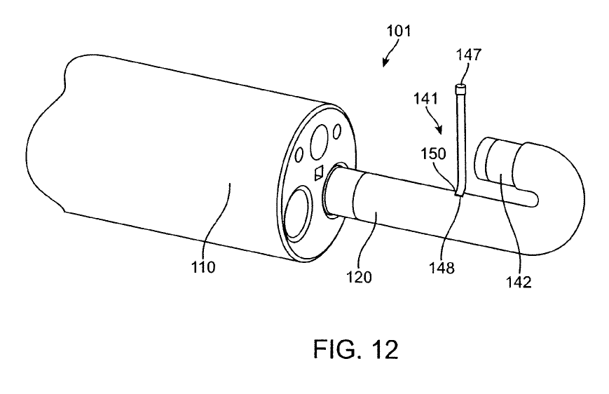

As shown in FIG. 12, the minor endoscope 120 shown in FIG. 11 may include an instrument 141, such as snares, electrocautery or biopsy forceps. The instrument 141 may be integrated directly into a channel 148 of the minor endoscope 120. The channel 148 has an opening 150 on the minor endoscope's distal end region that is outside of the distal end of the main endoscope 110. Preferably, the instrument 141 can still be manipulated to move in or out of the channel 148 of the minor endoscope 120 by manipulating a handle of the instrument 141 on the proximal end. But the instrument 141 may not be removed from the channel 148 of the minor endoscope 120 and replaced with a different instrument. Such an arrangement may minimize the space requirements of the instrument 141, allowing for additional space in the channel 148 of the minor endoscope 120 for additional electrical wires and/or insulation.

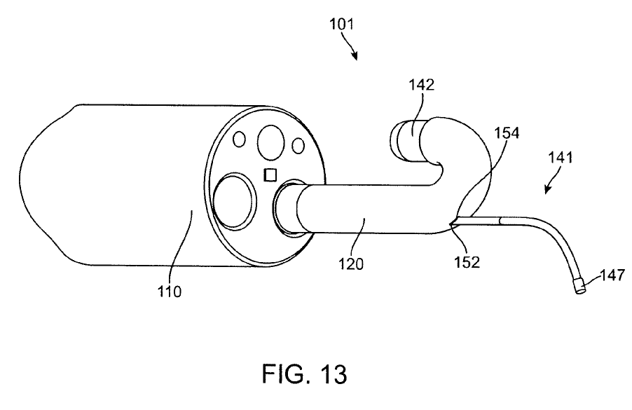

FIG. 13 illustrates a variation to the embodiment shown in FIG. 12. In this embodiment, the instrument 141 extends outside of the minor endoscope 120 through an opening 152 on a distal end region of the minor endoscope 120 and projects forwards beyond the minor endoscope 120. In this embodiment, the operator may withdraw the minor endoscope 120 back toward the distal tip of the main endoscope 110, so that the instrument 141 that projects beyond the minor endoscope 120 is closer to the distal tip of the main endoscope 110, making it easier to manipulate and control instrument 141. In this embodiment, it may be made possible to remove the instrument 141 from the channel 154 of the minor endoscope 120 so that the channel 154 may serve as an accessory channel for other accessory devices. The instrument 141 can be manipulated to move proximally or distally with respect to the minor endoscope 120 by manipulating a handle of the instrument 141 on the proximal end.

In an additional embodiment of the present invention, the auxiliary imaging device includes a wireless transceiver, associated circuitry and a battery. The wireless transceiver is configured to receive video signals from the imaging unit of the auxiliary imaging device and to transmit them wirelessly to a control box. Alternatively, the wireless circuit may be implemented in a flexible PCB or the handle of the minor endoscope. The control box may also include a wireless transceiver. This wireless transceiver enables the control box to receive wireless video signals from the imaging device and transmit control commands to the imaging device.

The wireless signal transmission and the use of batteries eliminate the need for electrical conductors within the tubular body 36. This reduces the restrictions imposed by electrical conductors to the physician's movements of the endoscope. Additionally, reducing the number of electrical conductors in the catheter and the flex-PCB allows for a larger diameter channel to be included in the catheter.

During endoscopy, a physician may first insert the main endoscope 10 into a body cavity. She may then straighten the flexible link 44 of the minor endoscope 20 and then insert the straightened distal end of the minor endoscope 20 into the channel 22 of the main endoscope's insertion tube 12 from the handle 18. The minor endoscope 20 can then be pushed towards the distal end 16 of the main endoscope 10. When the auxiliary imaging device 42 and flexible link 44 are pushed out of the distal end 16 of the main endoscope 10, the flexible link 44 resumes its natural bent configuration as shown in FIG. 2. If the minor endoscope 20 does not have an instrument fixed thereon as shown in FIGS. 8 and 12, the physician may then straighten an instrument 41 then insert the straightened instrument 41 into the channel 48 of the minor endoscope 20. The instrument 41 can then be pushed towards the distal end of the minor endoscope 20. When the instrument 41 is pushed out of the distal end of the channel 48, the distal end of the instrument 41 resumes its natural bent configuration as shown in FIGS. 4-7. The physician may also insert a second instrument into a second channel of the main endoscope 10.

The physician may use the two imaging devices 14, 42 to examine the body cavity, and then use the instrument 41 (or another instrument in the main endoscope 10) and one or both of the imaging devices 14, 42 to perform a desired procedure. For example, the instrument 41 (or the instrument in the main endoscope 10) may be a snare, and the physician may use the snare to remove a polyp. The physician may first maneuver the snare to place it around the polyp with the assistance of one or both of the imaging devices 14, 42. Viewing the images provided by the imaging devices 14, 42, the physician can ensure that the snare is properly placed around the polyp. Then she can tighten the snare to remove the polyp.

While the imaging catheter has been described throughout the description as being deployed inside an endoscope, in other applications it may be deployed through other methods such as through a straight tube or cannula, by a flexible insertion tube, or by a guide wire.

1. An endoscope assembly comprising:
an endoscope that includes a tubular body, a retrograde-viewing imaging device disposed at a distal end region of the tubular body, and a channel extending through the tubular body; and
an instrument extending through the channel of the endoscope and exits from a distal opening of the channel.

2. The endoscope assembly of claim 1, wherein the instrument includes a cable and a head disposed at a distal end of the cable.

3. The endoscope assembly of claim 2, wherein the head includes one of a snare, an electrocautery or a biopsy forceps.

4. The endoscope assembly of claim 2, wherein the cable includes an electrical wire for providing electric power to the head.

5. The endoscope assembly of claim 1, wherein a portion of the instrument that extends outside of the distal opening of the channel of the endoscope includes a bend.

6. The endoscope assembly of claim 5, wherein the instrument bends at an angle between 30° to 150°.

7. The endoscope assembly of claim 6, wherein the instrument bends at an angle between 45° to 135°.

8. The endoscope assembly of claim 6, wherein the instrument bends at an angle between 45° to 90°.

9. The endoscope assembly of claim 6, wherein at least the portion of the instrument forming the bend is made from a flexible shape memory material.

10. The endoscope assembly of claim 1, wherein at least a distal portion of the instrument is steerable.

11. The endoscope assembly of claim 1, wherein the instrument is moveable along the channel of the endoscope and rotatable relative to the channel of the endoscope.

12. The endoscope assembly of claim 1, wherein the distal opening of the channel is on a side surface of the distal end region of the tubular body.

13. The endoscope assembly of claim 1, wherein the distal opening of the channel is on a distal end of the tubular body.

14. The endoscope assembly of claim 1, wherein the channel of the tubular body and the instrument are integrated so that the instrument cannot be removed from the channel, but the instrument has limited movement in or out of the channel.

15. The endoscope assembly of claim 1, wherein the opening of the channel faces forward away from a proximal end of the endoscope, and wherein the instrument projects forwards beyond the endoscope.

16. The endoscope assembly of claim 1, wherein the endoscope is a minor endoscope, wherein the endoscope assembly further includes a main endoscope that includes an insertion tube, a forward-viewing imaging device disposed at a distal end region of the insertion tube, and a channel extending through the insertion tube, and wherein the minor endoscope extends through the channel of the insertion tube and exits from a distal opening of the channel of the insertion tube.

17. The endoscope assembly of claim 16, wherein the minor endoscope is moveable along the channel of the insertion tube and rotatable relative to the channel of the insertion tube.

18. The endoscope assembly of claim 1, further comprising a control box connected to the instruments to provide a monopolar current to the instruments.

19. An endoscope assembly comprising:
an endoscope that includes a tubular body and a retrograde-viewing imaging device disposed at a distal end region of the tubular body; and
an instrument fixed to the distal end region of the tubular body.

20. The endoscope assembly of claim 19, wherein the instrument includes a cable and a head disposed at a distal end of the cable.

21. The endoscope assembly of claim 20, wherein the head includes one of a snare, an electrocautery or a biopsy forceps.

22. The endoscope assembly of claim 21, wherein the cable includes an electrical wire for providing electric power to the head.

23. The endoscope assembly of claim 19, wherein the instrument is perpendicular to the distal end region of the tubular body.

24. The endoscope assembly of claim 19, wherein at least the portion of the instrument is made from a flexible shape memory material.

25. The endoscope assembly of claim 19, wherein the endoscope is a minor endoscope, wherein the endoscope assembly further includes a main endoscope that includes an insertion tube, a forward-viewing imaging device disposed at a distal end region of the insertion tube, and a channel extending through the insertion tube, and wherein the minor endoscope extends through the channel of the insertion tube and exits from a distal opening of the channel of the insertion tube.

26. The endoscope assembly of claim 25, wherein the minor endoscope is moveable along the channel of the insertion tube and rotatable relative to the channel of the insertion tube.

27. The endoscope assembly of claim 19, further comprising a control box connected to the instruments to provide a monopolar current to the instruments.

28. A method of performing a medical procedure, the method comprising:
inserting a main endoscope with a forward viewing imaging device into a body cavity;
inserting a minor endoscope with a retrograde viewing imaging device into a channel of the main endoscope; and
using the two imaging devices to examine the body cavity.

29. The method of claim 28, further comprising using an instrument associated with the minor endoscope to perform a medical procedure with assistance from images provided by one or both of the imaging devices.

30. The method of claim 29, further comprising inserting the instrument into a channel of the minor endoscope.

31. The method of claim 30, further comprising inserting an instrument into a second channel of the main endoscope and using the instrument to perform a medical procedure with assistance from images provided by one or both of the imaging devices.
